(19) United States
(12) Patent Application Publication
(10) Pub. No.: US 2024/0410812 A1
(43) Pub. Date: Dec. 12, 2024

(54) OPTICAL PARTICLE COUNTER AND METHODS

(71) Applicant: ENTEGRIS, INC., Billerica, MA (US)

(72) Inventor: Michael Manfred, Minnetonka, MN (US)

(21) Appl. No.: 18/732,519

(22) Filed: Jun. 3, 2024

Related U.S. Application Data
(60) Provisional application No. 63/471,410, filed on Jun. 6, 2023.

(51) Int. Cl. G01N 15/1434; G01N 15/14

(52) U.S. Cl. CPC G01N 15/1434; G01N 2015/1486

(57) ABSTRACT

This description relates to optical particle counters, methods of using optical particle counters, and methods of reducing particle count errors during use of an optical particle counter. The method includes placing an optical isolator between the laser and the flow cell to allow laser light to pass into the flow cell, and to reduce the intensity of light re-directed back into the laser as optical feedback capable of causing mode hopping.

### CROSS-REFERENCE TO RELATED APPLICATIONS

This application claims the benefit under 35 USC 119 of U.S. Provisional Patent Application No. 63/471,410, filed Jun. 6, 2023, the disclosure of which is hereby incorporated herein by reference in its entirety.

### FIELD

This description relates to optical particle counters, methods of using optical particle counters, and methods of reducing particle count errors during use of an optical particle counter.

### BACKGROUND

Optical particle counters have a range of commercial and industrial uses for identifying the presence or amount of certain types of particles within a fluid. The fluid may be a liquid (e.g., an aqueous or organic liquid) or a gas (e.g., clean air of “clean room,” or an exhaust gas).

In certain applications the fluid is a “slurry” (also referred to as a “particle dispersion” or “particle suspension”) that contains small particles dispersed or suspended in a liquid medium. In specific, the slurry may be of a type used with a CMP process (“chemical mechanical planarization” or “chemical mechanical processing”) to process a surface of a semiconductor wafer or microelectronic device (a “CMP substrate”). Specialized optical particle counters are used in these applications to detect relatively large particles (e.g., agglomerated particles) present in the slurry.

The CMP slurry contains small abrasive particles dispersed in an aqueous medium. The slurry is used to planarize a semiconductor wafer surface by applying the slurry to the surface and, using a moving pad (“CMP pad”), contacting the pad and the slurry with pressure against the surface. The slurry and pad are pressed against the surface to abrasively wear away minute amounts of material from the semiconductor wafer surface and to thereby produce an extremely flat, i.e., “planarized,” surface.

The sizes of particles in the slurry can be selected to provide a selected abrasive effect. A slurry can be prepared to have a desired size range of particles, with a size distribution of particles often having a form of a normal (i.e., bell-shaped or Gaussian) curve. Over time, however, after a slurry is prepared and before the slurry is used, individual particles of a slurry tend to coalesce and form larger-sized “agglomerate” particles. These agglomerate particles can be large enough to produce scratches in a semiconductor wafer surface during a planarization step.

An optical particle counter can be used to detect particles in a slurry that are undesirably large, including agglomerate particles formed from multiple individual abrasive particles. In use to detect the agglomerate particles in the slurry, an optical particle counter directs a focused laser light through a slurry sample as the slurry sample moves through a small transparent conduit referred to as a “flow cell.” The laser light passing through the moving slurry can be reflected or interrupted when an agglomerate particle passes through the light. The particle counter includes one or more optical detectors arranged relative to the moving slurry sample to receive light from the laser that passes through or is reflected by the slurry. A change in the intensity of laser light received by a detector can indicate an undesirably large particle in the slurry, such as an agglomerate.

### SUMMARY

An optical particle counter is an extremely sensitive measurement device that relies on a finely-tuned combination of highly-refined optical components such as a laser and transmissive optical devices such as a flow cell, optional filters, electronic components such as optical detectors and an electronic control system, as well as mechanical components. The combined components are controlled and monitored by computer software that must be programmed and applied to a specific measurement application to correctly interpret electronic signals produced by the optical detectors that receive and measure the intensity of laser light that has passed through or is reflected by a slurry. The system can be highly sensitive to extremely small differences in operating conditions, variability in the performance of components of the system (e.g., laser wavelength and power consistency, which may be affected by laser temperature and current input), and properties of a slurry and slurry components (liquid medium and particles). Changes or variability in one or more of these may cause the optical particle to produce incorrect readings, i.e., “particle count errors.”

When an optical particle counter produces particle count errors, the source of the errors may be obvious, or may be latent and very difficult to identify from among the large number of variabilities, inputs, and operating conditions that combine to produce a measured result. When an optical particle counter produces a reading that is suspected to be erroneous, the potential sources of the error can be numerous. Identifying the specific cause of the error may be a very challenging task that requires a close review of all of the different optical, computer, and electronic components of the apparatus.

As described herein, certain types of particle count errors may be caused by “mode hopping” of a laser. Further, in addition to many other potential causes, mode hopping may be caused by light from a laser used to perform the particle size measurement of a slurry being scattered and re-directed from particles of a slurry back into the laser, i.e., “optical feedback.” When using certain types of optical particle counters are used to measure the presence of undesirably large particles of a slurry such as a CMP slurry, light that is directed into the slurry may strike small particles (micron or nanoscale particles) of the slurry and become scattered and re-directed in a significant amount back into the laser. The scattered and re-directed light that re-enters the laser may induce the effect known as “mode hopping” of the light emitted by the laser. Mode hopping by a laser has the effect of producing variability in the light emitted from the laser, such as unwanted variability in the intensity or frequency of the emitted laser light. When the varying (irregular) laser light is produced by a laser of an optical particle detector, an optical sensor of the optical particle counter that receives that light from the laser can produce erroneous signals, such as a signal that indicates a much higher concentration of detected relatively large particles in a slurry. Potentially, the error may cause the optical particle counter to report a result (particle count) that is more than one-hundred times higher than an expected or known particle count of the slurry.

In one aspect, the invention relates to an optical particle counter. The particle counter includes: a flow cell adapted to contain a flow of liquid dispersion; a laser that generates a beam of laser light directed at the flow cell; an optical isolator located between the laser and the flow cell adapted to allow light to pass in a direction from the laser to the flow cell, and to prevent laser light that is reflected from the flow cell from entering the laser as optical feedback; and an optical detection system for detecting laser light that exits the flow cell.

In another aspect, the invention relates to a method of detecting particles in a liquid dispersion using an optical particle counter. The method includes: providing a flow of liquid dispersion through a flow cell, the liquid dispersion comprising a liquid medium with particles dispersed in the liquid medium; using a laser, generating a beam of laser light; passing the laser light through the flow of liquid dispersion in the flow cell; before passing the laser light through the flow of liquid in the flow cell, passing the laser light through an optical isolator located between the laser and the flow cell to allow the laser light to reach the flow cell and to prevent laser light that is scattered by the liquid dispersion within the flow cell from entering the laser as optical feedback; and detecting laser light that exits the flow cell.

In another aspect, the invention relates to a method of reducing mode hopping of a laser of an optical particle counter that includes a flow cell that contains a liquid dispersion comprising particles dispersed in a liquid. The laser directs laser light into the flow cell and the liquid dispersion. An optical detector detects laser light that exits the flow cell. The method includes placing an optical isolator between the laser and the flow cell to allow laser light to pass into the flow cell, and to reduce the intensity of light re-directed back into the laser as optical feedback capable of causing mode hopping.

### BRIEF DESCRIPTION OF THE DRAWINGS

FIG. 1 shows a prior art optical particle counter.

FIG. 2 shows an optical particle counter as described.

### DETAILED DESCRIPTION

The following describes optical particle counters that are useful to detect and measure the presence of certain types of particles in a liquid slurry.

The optical particle counters (or “counters”) can be useful to detect relatively large-sized particles (e.g., relatively large “agglomerates”) in a slurry that contains a concentration of these larger particles along with smaller particles suspended in a liquid medium. The slurry can contain any type of liquid medium and any type of solid particles. The following description will be directed toward one specific example of an application of the inventive optical particle counters and methods to detect certain relatively large-sized particles that can be present in a slurry used for chemical-mechanical planarization of a semiconductor substrate.

Chemical mechanical planarization (CMP) is a process by which chemical and mechanical forces are used together to polish a surface. Chemical mechanical planarization is used for various specific processes by semiconductor device manufacturers to prepare a semiconductor wafer for a manufacturing step. Prior to deposition or fabrication of complex micro- and nano-scale semiconductor components, a working surface of a substrate (e.g., a 300 mm semiconductor wafer that contains microelectronic devices) should meet stringent tolerances for flatness and smoothness to maximize quality and reproducibility. The processing (“planarization”) is performed using a CMP slurry, which is a liquid dispersion that contains a concentration of small (e.g., nanoscale) abrasive particulates suspended (“dispersed”) in a liquid medium.

The abrasive particles can be any type of abrasive particles useful in a chemical mechanical processing composition. Examples include various forms such as zirconia, alumina, ceria, and silica, and other ceramic materials. Any of these may be doped, undoped, and may be prepared by any of various known methods for the different types of particles. The abrasive particles are dispersed or suspended throughout the liquid medium. Various types of abrasive particles (e.g., charged, aggregated, non-charged, non-aggregated) are well known and available commercially. The individual particles may be spherical or nearly spherical in shape, but can have other shapes as well such as generally elliptical, square, or rectangular cross-sections. The individual particles are referred to as primary particles. Commonly, the individual (primary) particles become clustered or bonded together to form a larger particle (“aggregate particle”) from the multiple individual particles.

Aggregate particles that contain a few to several individual particles (e.g., 2, 3, 5, or 10 particles) are common and useful in a slurry. But aggregate particles can grow to a size that becomes large enough for the aggregate particle to cause damage to a substrate during processing. Within a CMP slurry, abrasive particles may coalesce and form larger agglomerate particles due to a pH shift, shear stress, or temperature effects. It is possible for some particles to become excessively large and take on a form of a large “agglomerate” particle or “gel” particle. In a slurry, sizes of individual, useful abrasive particles and acceptable aggregate particles can be on a sub-micron, e.g., nanometer scale. Useful abrasive particles (individual, or acceptable aggregate particles) may have an average particle size in a range from about 0.1, 0.5, 1, 5, 10, or 20 microns to about 100 microns. Larger unwanted aggregate particles have sizes that are greater than the sizes of the useful abrasive particles, e.g., greater than the D90, D95, or D99 of the useful particles, and may be large enough to damage a substrate during processing.

A slurry analyzed by a system as described may contain any suitable amount of abrasive particles, e.g., from an amount of about 0.01, 0.05, 1, 2 or 5 weight percent to about 10, 20, or 30 weight percent abrasive particles based on total weight slurry. The particles have a size distribution that includes a high percent of the total particles having a particle size in a micron range, e.g., at least 90 or 95 percent of particles in the slurry have a particle size of less than 100, 50, 10, 1, 0.5, or 0.1 microns, e.g., at least 90 or 95 percent of the particles have a particle size of less than 5, 1, 0.5, or 0.1 microns, i.e., a measured D90 or D95 of less than 100 microns, or a measured D90, D95, or D99 of less than 5, 1, 0.5 or 0.1 microns.

The slurry contains the abrasive particles dispersed in a liquid medium that typically contains a high concentration of water and an optional small amount of organic additive such as a solvent, which may be a lower alcohol (e.g., methanol, ethanol, etc.), ether (e.g., dioxane, tetrahydrofuran, etc.), among others. An example liquid carrier may comprise, consists essentially of, or consists of water, more preferably deionized water. A carrier that consists essentially of water can contain up to (not more than) 3, 2, 1, 0.5, 0.1, or 0.05 weight percent of another liquid, e.g., a non-water (organic) solvent such as a lower alcohol (e.g., methanol, ethanol, etc.), ether (e.g., dioxane, tetrahydrofuran, etc.), or the like.

To achieve the high quality requirements and high process yield requirements needed for current microelectronic device manufacturing, every variable present in a manufacturing step must be monitored and controlled as closely as possible, including the composition of a CMP slurry used during a planarization step. Potential variabilities of a CMP slurry include the concentration and distribution of abrasive particles within the slurry, particularly the presence and concentration of larger-sized aggregate particles. Large agglomerate particles (e.g. agglomerates particles having a size of 0.5 microns or larger) in a CMP slurry can cause scratch and dig defects on a surface of a wafer during CMP processing. As a result, it is important to monitor the size distribution and concentration of the particulates in the CMP slurry, particularly the presence of aggregate particles that are of an undesirably large size.

Generally, an optical particle counter uses a focused laser beam to detect particles contained in a liquid slurry. The laser beam is directed at a moving sample of the slurry and is transmitted at least partially through the slurry. The light of the laser beam may be transmitted entirely through the slurry, or may be blocked, scattered, or reflected by certain particles in the slurry as the sample passes through the laser beam. Certain small particles such as micron and nano-scale particles that are useful in the slurry may not interrupt or reflect the light of the laser, while larger size particles, e.g., larger-size agglomerates having a particle size that is larger than the useful slurry particles, may either interrupt the light or cause the light to be reflected, deflected, or scattered.

Optical detectors arranged about the sample collect light that passes through the slurry or that is reflected, scattered, or deflected by particles of the slurry. The particle counter uses information from the transmitted light or from scattered or deflected light to calculate amounts or sizes of particles in the slurry sample.

Example systems include an optical detector on a opposite side of the laser that detects light from the laser after the beam has passed through the slurry. In these example systems, a particle of the slurry that is of sufficient size, that passes through the path of the laser beam will interrupt light of the laser and temporarily reduce the intensity of the light. The particle is recognized by a temporary reduction in the strength of laser light detected by the optical detector. This type of system is referred to as an “extinction”-type optical particle counting system.

Another type of an example system includes one or more optical detectors arranged relative to a slurry sample that allow the detectors to receive light from the laser that is scattered or deflected by relatively large particles in the slurry sample. In these example systems, a relatively large particle of the slurry that passes through the path of the laser beam will scatter or deflect light of the laser, and is recognized as scattered or deflected light detected by an optical detector arranged to sense this type of scattered or deflected light. This type of system is referred to as an “scattering”-type particle detecting system.

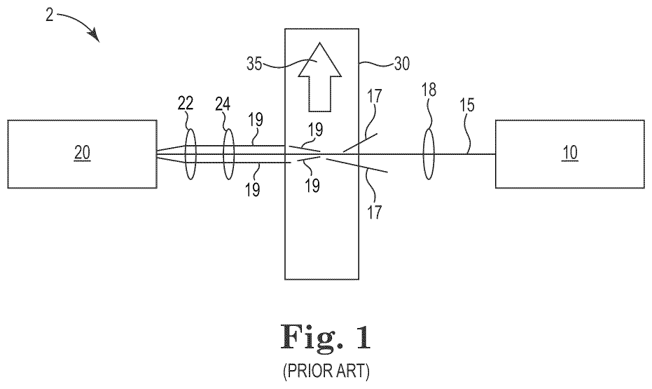

Referring to FIG. 1, illustrated is a prior art optical particle counter 2 for detecting relatively large (excessively-large, agglomerate) particles in a CMP slurry that contains the unwanted large agglomerate particles in combination with smaller, micron or nano-scale useful slurry particles. Flow cell 30 is made of an optically-transparent material and includes vertical sidewalls that form sides of a channel that is adapted to contain a flow of a sample CMP slurry 35. A flow cell may be made of a transparent material such as quartz or sapphire. An example flow cell may define an internal channel having a rectangular cross-section having a width and thickness useful to allow flow of a CMP slurry through the channel during a process of counting particles using the optical particle counter. An example thickness (the direction aligned with the laser as the laser enters the channel) may be in a range from 200 to 400 um. An example width (the direction transverse to the laser as the laser enters the channel) may be in a range from 1.5 to 2.0 mm.

Laser 10 produces laser light beam 15 that is directed to pass through lens 18 and flow cell 30. The laser light will pass through the slurry and the useful micron or nano-scale particles, but will be interrupted or scattered by larger agglomerate particles. Light that is transmitted through flow cell 30, including an amount of scattered light 19, passes through lenses 22 and 24 and is detected by optical detector 20, which is capable of detecting the scattered light focused by lenses 22 and 24. In response to optical detector 20 detecting an amount of the scattered light 19, detector 20 produces an electronic digital or analog output signal that correlates to the intensity of the received scattered light 19.

During use, large or agglomerated particles in the CMP slurry passing through flow cell 30 become scattered to form scattered light 19 as the beam passes through flow cell 30 and sample 35. The scattered light 19 is received and detected by optical detector 20 and converted into an electronic signal. By monitoring the amount of scattered light 19 that is received and detected by optical detector 20, operational software of optical particle counter 2 may detect, monitor, and report the presence and concentration of large agglomerate particles that are present in the sample CMP slurry 35 as the sample passes through flow cell 30.

Laser 10 and detector 20 can each be a laser and a detector that is useful for an optical particle counter as illustrated. An example of a useful laser may be a single mode laser that emits a single frequency of light having a wavelength in a range from 600 to 700 nanometers. Examples are commercially available, with examples being semiconductor laser diode-type lasers that emit light at a wavelength of 635 nanometers at a power in a range from 7 to 50 milliwatts. Examples of useful optical detectors 20 are also commercially available, such as Hamamatsu S2506-02 and Hamamatsu S6967.

An optical particle counter such as that shown at FIG. 1 can be highly sensitive to extremely small differences in operating conditions, variability in the performance of components of the system (e.g., laser wavelength and power consistency, which may be affected by laser temperature and current input), and properties of a slurry and slurry components (liquid medium and particles). Changes or variability in one or more of these features of counter 2, and other conditions and features of its operation, may cause counter 2 to produce erroneous readings, i.e., “particle count errors.”

Generally, a particle count errors may result from a multiple causes, which may be either be obvious, or may be latent and very difficult to identify from among the large number of variabilities of the inputs and operating conditions of an optical particle counter that combine to produce a measured result. To reduce or eliminate particle count errors, a large number of potential sources of the error must be identified and controlled. Identifying or controlling causes of a potential particle count errors may be a very challenging task that requires a close review of all of the many different optical components, computer and software programming, and electronic components of the optical particle counter including operating conditions (temperature) and all operating inputs (e.g., current used for operating a laser).

When considering potential sources of particle count errors, the operation of the various optical components of the counter, separately or on combination, can be one of the many potential sources. The operation of the laser is one possible source, including how conditions (temperature) and input (electrical current) may affect light output. A laser is highly sensitive to variabilities of input and operating conditions, including operating temperature (“laser case temperature”), variability of an input current, and “optical feedback,” which is light that passes into the laser from the laser exterior.

Optical feedback can affect the performance of a laser by changing the nature of the light that is emitted from the laser. Under certain conditions, light reflected back into a laser can cause the laser to experience “mode hopping,” which means that the light output of the laser shifts from one longitudinal mode (wavelength) to a different mode. Mode hopping can produce erratic changes in the wavelength of light being emitted from the laser, along with intensity fluctuations (intensity “noise”). There are different potential causes of mode hopping, including operating conditions of the laser (e.g., a laser's case temperature and current), variability in current used to operate the laser, and optical feedback.

The Applicant has determined that when using an optical particle counter as shown in FIG. 1 to detect large agglomerate particles in a slurry (e.g., a CMP slurry) that contains mostly smaller particles, light that is emitted from the laser and directed at the flow cell and slurry can be scattered by the smaller particles in the slurry and may be directed back into the laser in an amount that is sufficient to produce mode hopping. Mode hopping due to optical feedback would not be an apparent cause for particle count errors in a system of FIG. 1. Other possible causes for particle count errors would include: the focused shape of the laser beam; temperature of the laser, which could induce mode hopping; or the beam not being centered in the flow cell.

As described herein, to avoid particle count errors caused by mode hopping due to light 17 that is scattered by smaller particles in a slurry 35, as shown at FIG. 1, an optical isolator is placed between laser 10 and flow cell 30 of a counter 2.

More generally, as identified by the Applicant and described herein, when using an optical particle counter (e.g., of a type shown at FIG. 1) to detect relatively large agglomerate particles in a slurry that contains mostly useful smaller (micron or nanoscale) particles, optical feedback can be produced by light that is emitted from a laser being scattered by the useful smaller particle slurry and re-directed back into the laser as optical feedback. The optical feedback can produce mode hopping, which can be a source of particle count errors produced by the optical particle counter.

According to optical particle counters described herein, a counter can include an optical isolator located between the laser and the flow cell. The optical isolator acts to control the passage of light of the laser beam by allowing light to flow in a direction from the laser to the flow cell, while reducing the amount of light or substantially preventing light from passing in a reverse direction from the flow cell into the laser. The optical isolator substantially reduces or effectively prevents light that is scattered by the smaller particles contained in a slurry flowing through the flow cell from being scattered and re-directed back into the laser as optical feedback. The reduced optical feedback prevents mode hopping by the laser.

Example optical isolators can be effective to allow light to effectively pass in one direction, i.e., from the laser to the flow cell, while reducing the intensity of light or essentially preventing light from passing in an opposite direction. An optical isolator allows a substantial amount of laser light to pass from the laser to the flow cell, e.g., up to or in excess of 90, 95, or 99 percent of the light emitted from the laser will pass through the optical isolator in a direction from the laser to the flow cell. The optical isolator reduces the intensity of, or substantially prevents, any light that becomes reflected by the slurry from passing back into the laser, e.g., may reduce the intensity of reflected light by at least 50, 80, 90, 95, or 99 percent.

One example of an optical isolator is the type referred to as a “Faraday optical isolator.” A Faraday optical isolator is a passive unidirectional, nonreciprocal devices that uses the phenomenon of magneto-optic rotation to isolate a laser beam source and protect the laser oscillator from reflections in an optical system. A Faraday isolator acts as an optical diode that allows the propagation of light in only one direction.

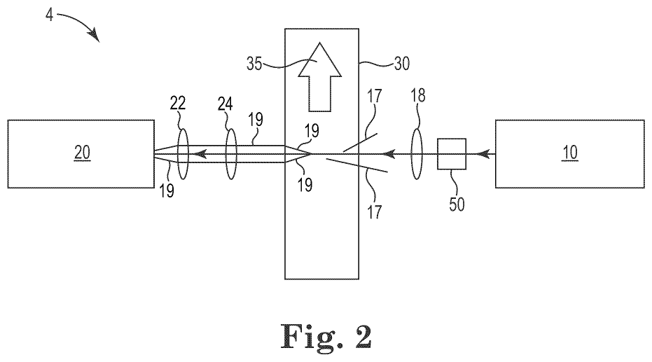

Referring to FIG. 2, illustrated is optical particle counter 4 for detecting excessively-large agglomerate particles in a CMP slurry that contains the agglomerate particles in combination with smaller, nano-scale particles. Counter 2 can be adapted to detect agglomerate particles in a CMP slurry that are larger than 80, 90, 95, or 99 percent of useful slurry particles, e.g., to detect agglomerate particles that have a size that is greater than the D80, D90, D95, or D99 of the useful slurry particles. For a slurry that contains at least 90, 95, or 99 percent particles of less than 0.7 microns, the counter may be adapted to detect agglomerate particles that are greater than 0.7 microns, for example. For slurries that contain smaller useful particles, the counter may be adapted to detect particles larger than 0.5 microns, or that are larger than 0.1, 0.15, 0.2, 0.5, 0.7, or 0.8 microns, and up to about 20 microns, while not sensing smaller useful slurry particles, e.g., particles smaller than 0.8, 0.7, 0.5, 0.2, 0.15, or 0.1 microns.

Illustrated particle counter 4 includes an arrangement of components that is similar to that of counter 2 of FIG. 1, other than the added presence of optical isolator 50 between laser 10 and flow cell 30. As in counter 2 of FIG. 1, laser 10 produces laser light beam 15 that passes through flow cell 30. The laser light will pass through the slurry and the micron or nano-scale useful slurry particles but will be interrupted or scattered by larger agglomerate particles. Light that is scattered (19) while passing through flow cell 30 is detected by optical detector 20. Scattered light 17 is light that is scattered off of smaller particles in the slurry and re-directed back toward laser 10.

During use, large or agglomerated particles in the CMP slurry passing through flow cell 30 produce scattered light 19, as laser light beam 15 passes through flow cell 30 and sample 35. The scattered light 19 is received and detected by optical detector 20. By monitoring the amount (e.g., intensity) of scattered light 19 (which is cause by the larger agglomerate particles) that is received by optical detector 20, operational software of optical particle counter 4 may detect, monitor, and report the presence and concentration of large agglomerate particles in the sample CMP slurry 35 as the sample passes through flow cell 30.

The illustrated optical particle counter 4 includes optical isolator 50 located between laser 10 and flow cell 30 to prevent optical feedback being received by laser 10 in the form of scattered and re-directed laser light 17 being allowed to pass back into laser 10. Optical isolator 50 allows light to pass in a first direction from laser 10 to pass through flow cell 30, through slurry 35, to be eventually received by optical detector 20 as scattered light 19. Optical isolator 50 also has the effect of reducing or preventing scattered and re-directed light 17 from passing back from cell 30 into laser 10 as optical feedback.

1. An optical particle counter comprising:
a flow cell adapted to contain a flow of liquid dispersion;
a laser that generates a beam of laser light directed at the flow cell;
an optical isolator located between the laser and the flow cell adapted to allow light to pass in a direction from the laser to the flow cell, and to prevent laser light that is reflected from the flow cell from entering the laser as optical feedback; and
an optical detection system for detecting laser light that exits the flow cell.

2. The counter of claim 1, wherein the optical detection system comprises an optical detector that receives laser light that passes through the flow cell, and is scattered by a particle in a liquid dispersion passing through the laser light.

3. The counter of claim 2, wherein the optical detector is adapted to detect particles of a size greater than 0.15 micron passing through the beam of laser light.

4. The counter of claim 1, wherein the optical isolator is effective to reduce mode-hopping by the laser compared to a comparable counter that does not include the optical isolator located between the laser and the flow cell.

5. The counter of claim 1, wherein the flow cell is a micro flow cell that includes a channel having a 0.4 mm×2 mm depth and width.

6. The counter of claim 1, comprising a liquid dispersion in the flow cell, the liquid dispersion comprising a liquid medium and particles dispersed in the liquid medium.

7. The counter of claim 6, wherein the liquid dispersion comprises:
at least 90 weight percent liquid medium, and
less than 10 weight percent dispersed particles,
based on total weight liquid dispersion.

8. The counter of claim 6, wherein the particles have an average particle size (D50) below 0.15 microns.

9. A method of detecting particles in a liquid dispersion using an optical particle counter, the method comprising:
providing a flow of liquid dispersion through a flow cell, the liquid dispersion comprising a liquid medium with particles dispersed in the liquid medium;
using a laser, generating a beam of laser light;
passing the laser light through the flow of liquid dispersion in the flow cell;
before passing the laser light through the flow of liquid in the flow cell, passing the laser light through an optical isolator located between the laser and the flow cell to allow the light to reach the flow cell and to prevent laser light that is scattered by the liquid dispersion within the flow cell from entering the laser as optical feedback; and
detecting laser light that exits the flow cell.

10. The method of claim 9, wherein an optical detector receives laser light that passes through the flow cell and detects a reduction in intensity of the laser light caused by a particle contained in a liquid dispersion passing through the laser light.

11. The method of claim 10, wherein the optical detector detects a reduction in intensity of the laser light caused by a particle having a size greater than 0.15 micron.

12. The method of claim 9, wherein the optical isolator is effective to reduce mode-hopping by the laser compared to a comparable counter that does not include the optical isolator located between the laser and the flow cell.

13. The method of claim 9, wherein the liquid dispersion comprises:
at least 90 weight percent liquid medium, and
less than 10 weight percent dispersed particles,
based on total weight liquid dispersion.

14. A method of reducing mode hopping of a laser of an optical particle counter that includes a flow cell that contains liquid dispersion comprising particles dispersed in a liquid, wherein the laser directs laser light into the flow cell and the liquid dispersion, and an optical detector detects laser light that exits the flow cell, the method comprising placing an optical isolator between the laser and the flow cell to allow laser light to pass into the flow cell, and to reduce the intensity of laser light re-directed back into the laser as optical feedback capable of causing mode hopping.

15. The method of claim 14, wherein the optical detector measures a reduction in intensity of the laser light when a particle contained in the liquid dispersion passes through the laser light.

16. The method of claim 14, wherein the laser experiences reduced mode hopping compared to a comparable optical particle counter that does not include the optical isolator between the laser and the flow cell.
